(19) United States
(12) Patent Application Publication
(10) Pub. No.: US 2012/0104164 A1
(43) Pub. Date: May 3, 2012

(54) Aircraft Floats

(76) Inventors: Saxon Grenfell Rudduck, South Australia (AU); Alan John Smith, Victoria (AU); Matthew Robert Tetlow, South Australia (AU)

(21) Appl. No.: 13/321,847

(22) PCT Filed: May 20, 2010
(86) PCT No.: PCT/IB10/01389

§ 371 Date: Nov. 22, 2011

(30) Foreign Application Priority Data
May 22, 2009 (AU) 2009902360
Oct. 27, 2009 (AU) 2009905235

(51) Int. Cl. B64C 25/66; B64C 25/56

(52) U.S. Cl. 244/101; 244/105

(57) ABSTRACT

This invention relates to an improved float for use with an aircraft having water landing capabilities comprising at least one float capable of increasing/decreasing its volume arranged to at least substantially support said aircraft in a floating on water status so that the fuselage of the aircraft is substantially above the water.

### CROSS-REFERENCE TO RELATED APPLICATIONS

This claims priority to Australian Patent Provisional Application Number 2.009902360, filed May 22, 2009 and Australian Provisional Patent Application Number 20099052.35, filed on Oct. 27, 2009. These prior applications are all hereby incorporated by reference herein in their entireties.

### BACKGROUND OF INVENTION

1. Field of the Invention

This invention relates to the performance of floats on an aircraft capable of operating on water. in particular, this invention relates to an improvement to existing floats that increases the volume of a float in a manner that reduces drag on the aircraft, does not increase the weight and may, in some cases, reduce the weight of the aircraft, and does not interfere with the operation of the wheels on an aircraft.

2. Background Art

Aircraft are usually designed to take off and land from land—“landplanes”. Sonic of these aircraft are adapted to be able to take off and land from water which is normally achieved by means of floats or pontoons suspended below the fuselage of the aircraft—“floatplanes”. These float planes often have wheels associated with the floats for land operations—“amphibious float planes”.

A common problem with float planes is the high air drag associated with the floats and the wheels fitted to the floats. The drag of the floats relates to their size and safety considerations require the floats to support 180% larger than required to support the weight of the aircraft. This high drag increases fuel consumption and hence reduces payload, reduces speed and hence productivity and also makes the floats prone to dangerous icing up in flight. The high fuel consumption increases operating costs and increases undesirable emissions such as carbon dioxide.

The high drag of these floats is caused by the large frontal area, large surface area, poor aerodynamic shape, sharp hydrodynamic features, and from the mounting structure. The result is an increased air drag of approximately 45% for a floatplane over the equivalent landplane variant.

There have been floatplane designs that incorporate retracting floats to reduce this drag. One desirable arrangement incorporates floats that fold up, and together, below the bottom of the aircraft fuselage. This arrangement reduces surface area, conceals the hydrodynamic surfaces and much of the mounting structure, and provides a better aerodynamic shape. Retracting floats can reduce air drag compared to fixed floats by up to 20%. An example of this is seen in U.S. Pat. No. 7,159,820 (Smith and Rudduck, January 2007)

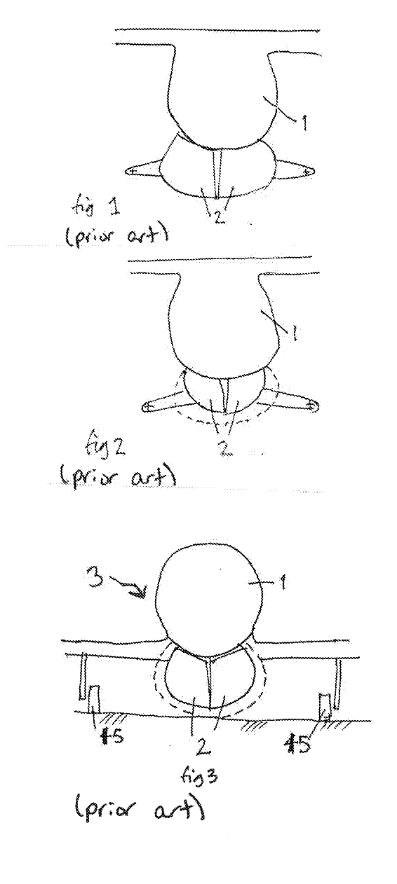

The aerodynamic drag of the floats in the retracted position can he further decreased by methods to reduce the volume of the floats once retracted and hence the frontal area and surface area. in one preferred embodiment, this method allows the full (180%) required volume of the floats to be available for operations on the water. FIG. 1 depicts a prior art cross section through a fuselage with the floats in the retracted position. FIG. 2 is the same prior art view and shows the reduced volume floats compared to the fixed volume floats shown in the broken line, These reduced volume floats are approximately 120% of the size required to support the weight if the aircraft.

Another problem with the large retracting floats (180%) floats is the limited space below some aircraft when on their wheels on the land. FIG. 3 shows a prior art cross section through a fuselage and shows how the smaller floats can allow the wheels to operate with adequate ground clearance not possible with the large floats shown in the broken line.

One prior art method to achieve this change of volume is to expand or contract the float longitudinally as shown in the above U.S. Pat. No. 7,159,820. Refer to FIGS. 8(a), (b) and (c). Another prior art method is to provide pneumatic blisters to the decks of the floats as shown in PCT/AU2008/00076 (Tigerfish. Aviation Pty. Ltd, January 2008) Refer to FIGS. 15(a) and (b).

Another problem encountered for the designer installing retracting floats to an aircraft is shown in FIGS. 8a, 8b and 8c. The existing wheels of an aircraft are an expensive element of the aircraft and it is desirable to retain them in use with an amphibious floatplanes. Aircraft typically have a nose wheel or wheels at the front of the fuselage and main wheels or wheels located a short distance aft of the centre of gravity. A common arrangement is for the main wheels to retract inwardly towards the centre line of the fuselage and are thus unable to operate if the floats are retracted. A practical solution, seen is this invention, to this is to introduce a gap between the floats for the wheels to be able to operate. The single float is now a front float and a rear float attached to the fuselage by two sets of legs. When the floats are required, they would swing down on their pivot to move into place.

Particular reference is drawn to FIG. 28c in PCT/AU2008/00076 (Tigerfish Aviation Pty Ltd, January 2008). This reference shows a design where a retracting float is moved to position below the wing allowing the existing main wheels of an aircraft such as the Boeing C17 airlifter to operate. In such a configuration there can be a very strong downwash of airflow from the wing and the flaps that will impinge on the float in this position. This can reduce the effectiveness of the wing and also damage the float. These two problems can also be relieved by dividing the floats into a front float and a rear float.

These floats described above are normally fixed to the aircraft but in some instances are arranged to retract up below the fuselage of the plane to reduce air drag and increase efficiency. In this situation, these floats traditionally have a displacement of 180% total (90% each float) of the maximum weight of the floatplane to provide a safety margin in the event of a leak in the floats. In addition the floats are required to be divided into a number of watertight compartments to provide a reserve of buoyancy. This large safety margin results in floats that are larger than required which increases weight, air drag and other aspects such as cost. In some instances with retracting floats, the large floats below the aircraft limit the use that can be made of the aircraft's existing wheels. This invention solves this problem by identifying a solution in which the float is divided into compartments allowing for increased volume.

### BRIEF SUMMARY OF THE INVENTION

This invention relates to an improved float for use with an aircraft having water landing capabilities (floatplane) comprising at least one float capable of increasing/decreasing its volume arranged to at least substantially support said aircraft in a floating on water status so that the fuselage of the aircraft is substantially above the water. The float has at least one hinged panel that when opened reveals at least one bag capable of being inflated to a desired volume.

In one preferred embodiment, the float has a longitudinally hinged panel on the deck of the float. This panel is arranged to open at one side and reveals a water tight flexible fabric bag that is attached to the underside of the panel and the top of the rebate in the float that accommodates the panel and bellows. The panel will be opened by a geared electric motor or other mechanical means.

When the panel is opened the volume of the float will be increased from the 120% to the 180%. As the panel opens and closes relief air is allowed to pass via a duct from atmosphere to the internal volume of the bag. This duct has its entry/exit to atmosphere well above water level and can be fitted with a valve if required to close the duct.

A second preferred embodiment is a useful variation of the first. The float has a pair of transverse hinged panels on the deck of the float. These panels are arranged to open in a vertical manner and also reveal water tight flexible fabric bag that is attached to the underside of the panels and the top of the rebate of the float that accommodates the panels and bellows. The panels will be opened by a geared electric or other mechanical means. One particular advantage of this second preferred embodiment is the bag is protected against waves and spray by the forward panel when the float is moving through the water at high speed.

Similarly to the first preferred embodiment, when the panels are opened the volume of the float will be increased from 120% to 180%. As the panels open and close relief air is allowed to pass via a duct from atmosphere to the internal volume of the bellows. This duct has its entry/exit to atmosphere well above water level and can be fitted with a valve to close the duct.

The panel, when opened, can be arranged to provide a foot trafficable area when the float is in the water and also to protect the bellows against damage from a jetty or dock.

A third preferred embodiment is that one float could comprise a series of access panels and a series of corresponding airbags. In this embodiment, a float is divided into watertight compartments each of which is outfitted with a panel and an airbag. The airbag, is similar to the bags described above, in that it is a tough, flexible, light weight fabric bag that is folded into a compact bundle and is provided with a gas pressurisation system to inflate the bag within the compartment if there is a water leak to maintain buoyancy. The leak can be detected by a sensor and the gas can come from an individual or common supply. The compartment will be fitted with a one-way air relief valve to allow the bag to operate readily.

The airbags can be designed to be easily removable for servicing and easily tested for individual flights.

The advantages of this embodiment are reduced frontal and surface areas resulting in reduced air drag; reduced weight of the float; reduced cost of the float and less bulky floats more readily able to be accommodated below an aircraft when retracted. In the event of leaks the bags will maintain a high percentage of original buoyancy and will be able to retain buoyancy if all compartments have leaks as can be expected if the floatplane is “raked” by small arms fire in policing or military operations.

This invention, as a whole, also solves the problem of wheels being unable or having difficulty in retracting due to float placement. If the floats are spaced to allow for a gap in the wheels, the floats would not affect wheel operation. In this embodiment, the keel line of a front float and the keel line of a rear float align with the keel lines of the aircraft. The stern of the front float is in the same position as prior art and acts as the planing step. The front of the rear float is shaped as typical bows seen in prior art. Apart from a loss of buoyancy this arrangement has been found to perform satisfactorily.

One skilled in this art would recognize that it is advantageous to close off the gap in some configurations for aerodynamic and hydrodynamic reasons. Sliding panels are one method to achieve this. The float can be split into a front float and a rear float when retracted but can be arranged for the floats to come together in the water landing position. If this instance were to occur, the floats would swing down the pivots and also move longitudinally to come together.

A further benefit of divided floats relates to lift in flight. Typical floats commonly generate useful lift in flight. This is achieved by the acceleration of the air over the top of the float relative to the airflow below. The faster air above has a drop in relative air pressure and the slower air below has an increase in pressure and the differential pressure results in lift. The downwash from the wing and flaps is directed through the opening between the front and rear floats to reduce loss of lift from the wing and damage to the floats. An additional benefit of this arrangement is by careful shaping of the rear of the front float and the front of the rear float substantial and useful lift can be generated by the accelerated airflow over the surface of the front uppermost in this arrangement. Sliding or hinged panels can resurrect the required aerodynamic or hydrodynamic shapes.

Other advantages and aspects of the present invention will become apparent upon reading the following description of the drawings and the detailed description of a preferred embodiment of the invention.

### DETAILED DESCRIPTION OF THE DRAWINGS

FIG. 1 depicts a prior art, cross-sectional view through the aircraft fuselage with the floats in the retracted position.

FIG. 2 depicts a prior art, cross-sectional view through the aircraft fuselage with the floats in a reduced volume state.

FIG. 3 depicts a prior at, cross-sectional view through the aircraft of the wheels in operation with the reduced volume floats.

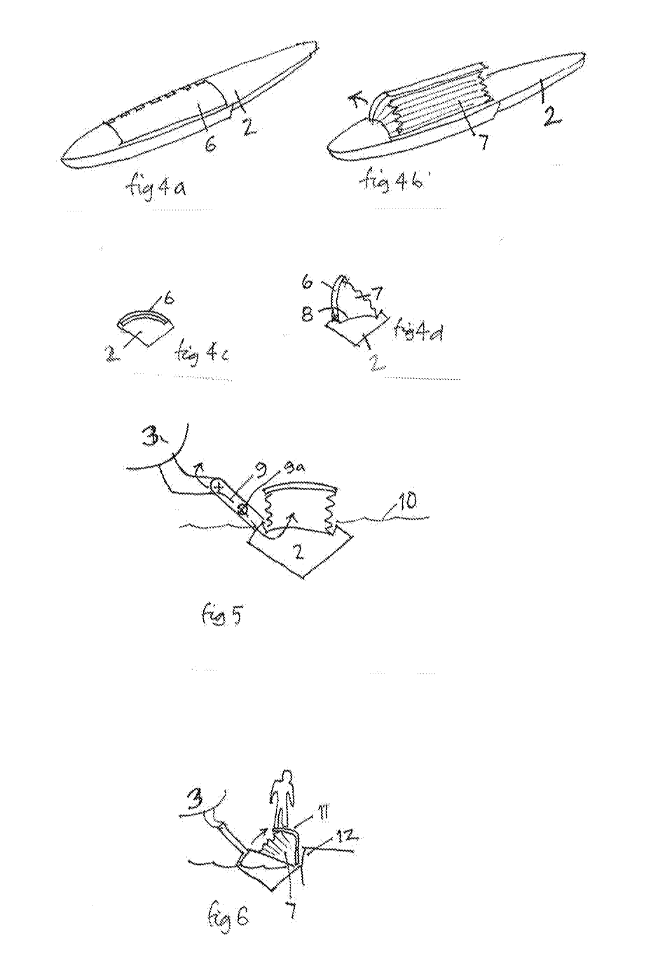

FIG. 4a depicts a float with a longitudinally binged panel in the closed position.

FIG. 4b depicts a float with a longitudinally hinged panel in the open position revealing the bag.

FIG. 4c depicts a cross-sectional view of the float in the closed position.

FIG. 4d depicts a cross-sectional view of the float in the open position.

FIG. 5 depicts a cross-sectional view of the float with the panel open utilizing the duet.

FIG. 6 depicts a cross-sectional view of the float with the panel open arranged for a foot trafficable area.

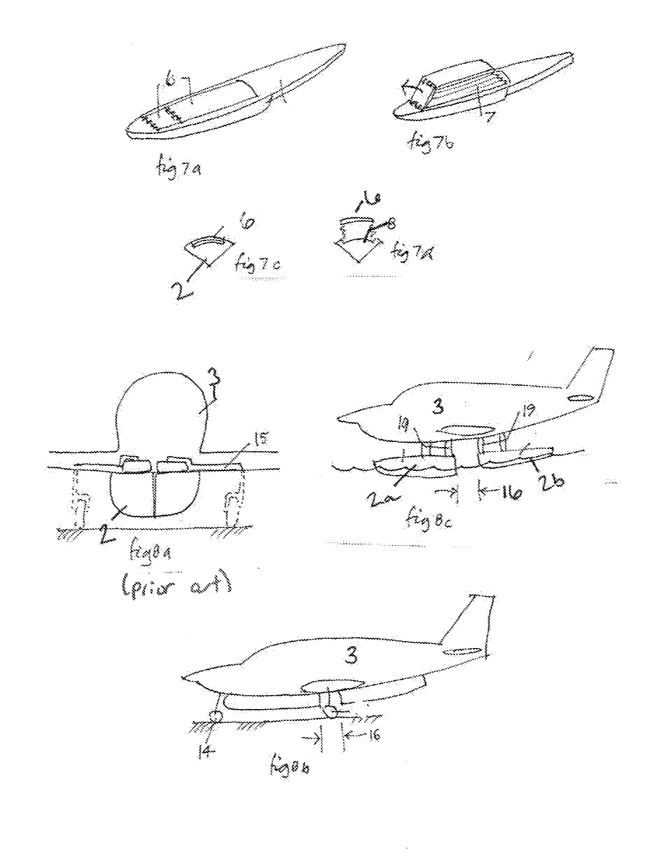

FIG. 7a depicts a view of the float with a transversely hinged panel in the closed position.

FIG. 7b depicts a view of the float with a transversely hinged panel in the open position.

FIG. 7c depicts cross-sectional view of the float in the closed position.

FIG. 7d depicts a cross-sectional view of the float in the open position.

FIG. 8a is a prior art view of the aircraft depicting the floats in a position that may conflict with the wheel operation.

FIG. 8b depicts a view of the aircraft floats in a split position allowing for wheel operation for a land landing.

FIG. 8c depicts a view of the aircraft floats in a split position allowing for wheel operation for a water landing.

FIG. 8d depicts a prior art, perspective view of the aircraft with standard undivided floats

FIG. 8e depicts a perspective view of the aircraft with divided floats.

FIG. 9a is a prior art, scrap view of an undivided float.

FIG. 9b is a scrap view of a divided float.

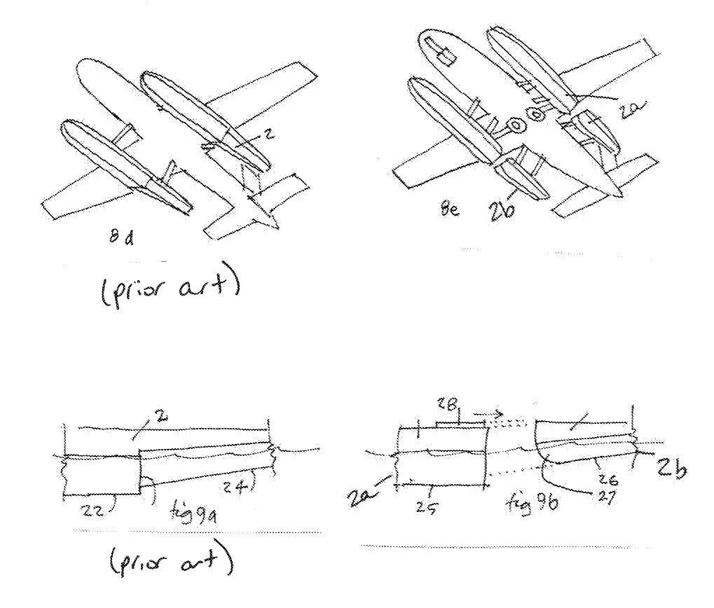

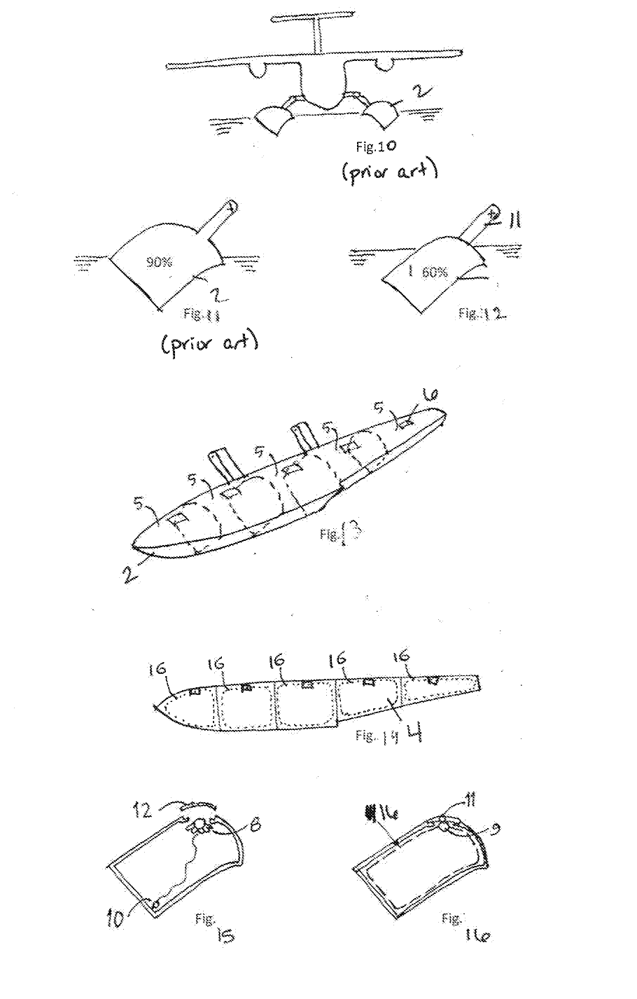

FIG. 10 is a prior art, cross-sectional view of an aircraft capable of a water landing.

FIG. 11 is a prior art view of a float with 90% displacement.

FIG. 12. is a view of a float with 60% displacement.

FIG. 13 is a view of the float with compartments.

FIG. 14 is a view of the float with compartments and airbags.

FIG. 15 is a view of a compartment with the access hatch in the open position for servicing.

FIG. 16 is a view of a compartment with the access hatch in the closed position.

### DETAILED DESCRIPTION OF THE PREFERRED EMBODIMENT

Turning to FIGS. 4a-7a, this invention relates to an improved float for use with an aircraft 3 having water landing capabilities having at least one float 2 capable of increasing/decreasing its volume arranged to at least substantially support said aircraft 1 in a floating on water status so that the fuselage of the aircraft 3 is substantially above the water 10. The float 2 has at least one hinged panel 6 that when opened reveals at least one bag 7 capable of being inflated to a desired volume.

FIGS. 4a-6 relate to a float 2 having a longitudinally hinged panel 6 that when opened reveals a bag 7 as seen in FIG. 4b. This panel is opened by a geared motor or other mechanical means (not shown). The bag 7 is a flexible bag that is attached to the underside of the panel 6 and the top of a rebate 8. As the panel 6 is opened, the volume of the float 2 can increase from 120% of the required volume to 180%, which is the volume typically needed for the floats to be operation in water. As the panel 6 opens and closes, relief air is permitted to pass by way of a duct 9 from the atmosphere to the internal volume of the bag 7. The duct can be fitted with a valve 9a if it is needed close the duct 9.

FIG. 6 depicts the float 2 being used in a manner to allow a path 11 for foot traffic. This would allow for easy access to a dock 12.

FIGS. 7a-7d relate to a float 2 having a transversely hinged panel 6. This is a variation of the above embodiment in that the panel 6 opens vertically to reveal the bag 7. As described above, ss the panel 6 is opened, the volume of the float 2 can increase from 120% of the required volume to 180%, which is the volume typically needed for the floats to be operation in water. As the panel 6 opens and closes, relief air is permitted to pass by way of a duct 9 from the atmosphere to the internal volume of the bag 7. The duct can be fitted with a valve 9a if it is needed close the duct 9.

One skilled in the art will recognize that a series of floats 2 can be utilized such as seen in FIGS. 8b, 8c, and 8e. If the float 2 is split into a front float 2a and rear float 2b, a gap 16 is created so that the wheels 15 can operate without obstruction from the float 2. The floats are attached to the aircraft by way of legs 19. These legs 19 can allow for pivoting movement as well as longitudinal movement if it desired to bring the front float 2a and rear float 2b closer together to bridge the gap 16.

Turning to FIG. 9b, one skilled in the art will note that the keel line 25 of the front float 2a and the keel line 26 of the rear float 2b is the same as in an undivided float of prior art, seen in FIG. 9a, In this arrangement, sliding panels 28 can bridge the gap between the front float 2a and rear float 2b.

FIGS. 12-16 detail the last arrangement of this invention. The situation commonly arises whereby the float 2 develop a leak that interferes with the integrity of the float 2. This embodiment relates to an improved float 2 capable of increasing/decreasing its volume arranged to at least substantially support said aircraft in a floating on water status so that the fuselage 1 of the aircraft 3 is substantially above the water. The float 2 has a series of watertight compartments 5 within the float 2 and each compartment 5 comprises an airbag 16. As water enters a compartment a sensor 10 triggers the airbag 16 to inflate by way of a gas pressurization system 9, This allows the float 2 to maintain buoyancy. The compartment 5 may be outfitted with a one-way relief valve 11 to allow the airbag to operate readily.

The invention may be described in terms of claims that can assist the skilled reader in understanding the various aspects and preferments of the invention. It will be appreciated by those skilled in the art that many modifications and variations may be made to the embodiments described herein without departing from the spirit and scope of the invention.

### INDUSTRIAL APPLICABILITY

As will be appreciated by those skilled in the various arts, this invention disclosed herein is not limited to the examples set our above and has wide application in many areas. This invention represents a significant advance in the art of floats for aircraft capable of a water landing.

What is claimed is:

1) An improved float for use with an aircraft having water landing capabilities comprising:
at least one float capable of increasing/decreasing its volume arranged to at least substantially support said aircraft in a floating on water status so that the fuselage of the aircraft is substantially above the water; said float having at least one hinged panel that when opened reveals at least one bag capable of being inflated to a desired volume.

2) The improved float as in claim 1, wherein said panel is opened or closed by mechanical means.

3) The improved float as in claim 1, wherein said at least one bag comprises any suitable water tight, flexible material such as fabric or plastic and is attached to the underside of said panel and to the top of a rebate.

4) The improved float as in claim 1, wherein said panel is arranged to provide for a foot trafficable area when said float is in the water.

5) The improved float as in claim 1, wherein at least one float may be a series of floats arranged in a manner to substantially support the aircraft and allow wheels on the aircraft to operate properly.

6) The improved float as in claim 1, wherein said at least one float may comprises a series of panels and a series of bags to allow for varying levels of float volume.

7) The improved float as in claim 1, wherein said panel is longitudinally hinged on the deck of the float.

8) The improved float as in claim 7, wherein the action of opening said panel inflates said at least one bag by way of a duct and increases the volume of the float; closing said panel deflates said at least one bag by way of said duct and decreases the volume of said float.

9) The improved float as in claim 1, wherein the float comprises a pair of hinged panels arranged in a transverse manner on the deck of said float.

10) The improved float as in claim 9, wherein the action of opening said pair of panels inflates said bag by way of a duct and increases the volume of the float; closing said pair of panels deflates said bag by way of said duct and decreases the volume of said float.

11) An improved float for use with an aircraft having water landing capabilities comprising:
at least one float capable of increasing/decreasing its volume arranged to at least substantially support said aircraft in a floating on water status so that the fuselage of the aircraft is substantially above the water; said float having a series of watertight compartments within said float; each compartment comprises an airbag.

12) The improved float as in claim 11, wherein said airbag comprises any suitable water tight, flexible material such as fabric or plastic and is folded into a compact bundle within said compartment; said airbag further comprises a gas pressurization system to inflate the bag within the compartment upon receiving a signal from a sensor that a water leak is detected within the float.

13) The improved float as in claim 11, wherein said compartment comprises a one way air relief valve.
